(19) United States
(12) Patent Application Publication
(10) Pub. No.: US 2023/0028376 A1
(43) Pub. Date: Jan. 26, 2023

(54) ABSTRACT LEARNING METHOD, ABSTRACT LEARNING APPARATUS AND PROGRAM

(71) Applicant: NIPPON TELEGRAPH AND TELEPHONE CORPORATION, Tokyo (JP)

(72) Inventors: Itsumi SAITO, Tokyo (JP); Kyosuke NISHIDA, Tokyo (JP); Kosuke NISHIDA, Tokyo (JP); Hisako ASANO, Tokyo (JP); Junji TOMITA, Tokyo (JP)

(73) Assignee: NIPPON TELEGRAPH AND TELEPHONE CORPORATION, Tokyo (JP)

(21) Appl. No.: 17/785,977

(22) PCT Filed: Dec. 18, 2019
(86) PCT No.: PCT/JP2019/049662

§ 371 Date: Jun. 16, 2022

(51) Int. Cl. G06F 40/279; G06N 3/08; G06N 3/04

(52) U.S. Cl. CPC G06F 40/279; G06N 3/08; G06N 3/0454

(57) ABSTRACT

The efficiency of summary learning that requires an additional input parameter is improved by causing a computer to execute: a first learning step of learning a first model for calculating an importance value of each component in source text, with use of a first training data group and a second training data group, the first training data group including source text, a query related to a summary of the source text, and summary data related to the query in the source text, and the second training group including source text and summary data generated based on the source text; and a second learning step of learning a second model for generating summary data from source text of training data, with use of each piece of training data in the second training data group and a plurality of components extracted for each piece of training data in the second training data group based on importance values calculated by the first model for components of the source text of the piece of training data.

### TECHNICAL FIELD

The present invention relates to a summary learning method, a summary learning device, and a program.

### BACKGROUND ART

Training data for a model that generates a summary using a neural network generally includes pairs of source text that is to be summarized and summary data that indicates correct summary results.

There are also models that require an input parameter (hereinafter referred to as a “query”) in addition to source text (e.g., NPL 1). Such a model makes it possible to generate a summary that conforms to the query. The training data for such a model includes parameter sets that each include source text, a query, and summary data (hereinafter, such training data is referred to as “training data that includes additional parameters”).

On the other hand, methods of generating a summary include an extractive method and a generative method. In an extractive method, a portion of the source text is extracted as-is. In a generative method, summary data is generated based on words or the like included in the source text. Hereinafter, a model that requires a query as input and generates summary data with the generative method is referred to as a “query-dependent generative model”.

### CITATION LIST

### Non Patent Literature

[NPL 1] Goncalo M. Correia, Andre F. T. Martins, A Simple and Effective Approach to Automatic Post-Editing with Transfer Learning, Proceedings of the 57th Annual Meeting of the Association for Computational Linguistics, pages 3050-3056, July 28 Aug. 2, 2019.

### SUMMARY OF THE INVENTION

### Technical Problem

Although there are many pieces of training data made up of pairs of source text and summary data, in the case of training a query generative model, there is not enough training data that includes additional input parameters in addition to source text.

The present invention has been made in view of the foregoing, and an object of the present invention is to increase efficiency in summary learning that requires an additional input parameter.

### Means for Solving the Problem

In order to solve the foregoing problems, a computer executes: a first learning step of learning a first model for calculating an importance value of each component in source text, with use of a first training data group and a second training data group, the first training data group including source text, a query related to a summary of the source text, and summary data related to the query in the source text, and the second training group including source text and summary data generated based on the source text; and a second learning step of learning a second model for generating summary data from source text of training data, with use of each piece of training data in the second training data group and a plurality of components extracted for each piece of training data in the second training data group based on importance values calculated by the first model for components of the source text of the piece of training data.

### Effects of the Invention

It is possible to increase efficiency in summary learning that requires an additional input parameter.

### BRIEF DESCRIPTION OF DRAWINGS

FIG. 1 is a diagram showing an example of a hardware configuration of a summary learning device 10 according to an embodiment of the present invention.

FIG. 2 is a diagram showing an example of a functional configuration of the summary learning device 10 according to the embodiment of the present invention.

FIG. 3 is a diagram showing an example of query-dependent data.

FIG. 4 is a diagram showing an example of query-independent data.

FIG. 5 is a flowchart for describing an example of a processing procedure of model learning processing.

FIG. 6 is a flowchart for describing an example of a processing procedure of summary generation processing.

### DESCRIPTION OF EMBODIMENTS

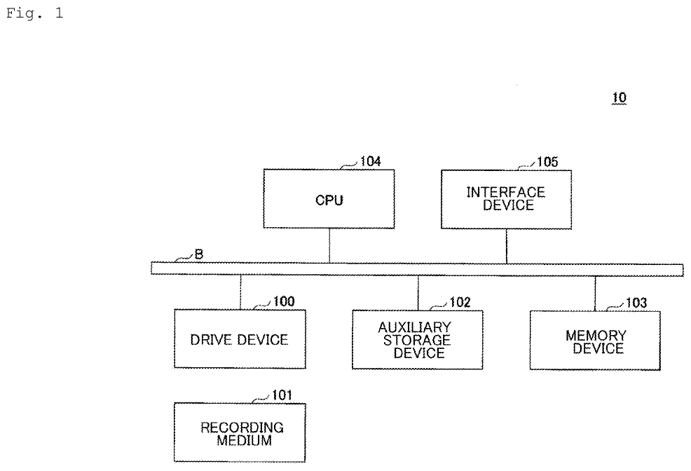

Hereinafter, an embodiment of the present invention will be described with reference to the drawings. FIG. 1 is a diagram showing an example of the hardware configuration of a summary learning device 10 according to an embodiment of the present invention. The summary learning device 10 of FIG. 1 includes a drive device 100, an auxiliary storage device 102, a memory device 103, a CPU 104, an interface device 105, and the like, which are connected to each other by a bus B.

A program that realizes processing in the summary learning device 10 is provided by a recording medium 101 such as a CD-ROM. When the recording medium 101 storing the program is set in the drive device 100, the program is installed in the auxiliary storage device 102 from the recording medium 101 via the drive device 100. However, the program does not necessarily need to be installed from the recording medium 101, and may be downloaded from another computer via a network. The auxiliary storage device 102 stores the installed program and also stores necessary files, data, and the like.

If a program launch instruction has been given, the memory device 103 reads and stores the program from the auxiliary storage device 102. The CPU 104 executes functions pertaining to the summary learning device 10 in accordance with the program stored in the memory device 103. The interface device 105 is used as an interface for connecting to a network.

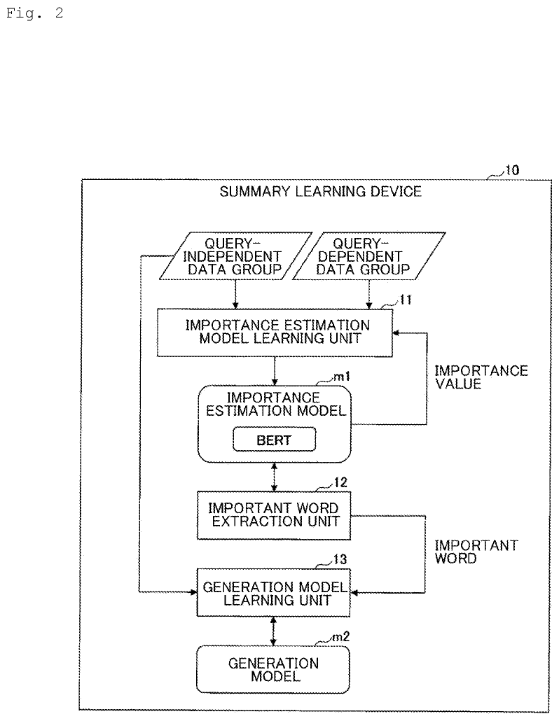

FIG. 2 is a diagram showing an example of the functional configuration of the summary learning device 10 according to the embodiment of the present invention. In FIG. 2, the summary learning device 10 includes an importance estimation model learning unit 11, an important word extraction unit 12, a generation model learning unit 13, and the like in order to perform query-dependent length-controlled summary learning. These parts are realized by processing in which one or more programs installed in the summary learning device 10 are executed by the CPU 104.

In “query-dependent length-controlled generative summary”, the term “query-dependent” means that a query is designated as an input parameter in addition to source text. For example, the focus of the summary may be the query. The term “length-controlled” means that the length of the data expressing the summary (hereinafter referred to as “summary data”) is designated (i.e., the number of words or the like that are to be included in the summary data is designated). The term “generative” means that the summary data is not made up of a portion of the text targeted for summary data generation (hereinafter referred to as “source text”) that has been extracted as-is, but rather is summary data that is generated from components (e.g., words) of the source text.

The importance estimation model learning unit 11 learns an importance estimation model m1 with use of all pieces of training data (a training data group) that have been prepared in advance. In the present embodiment, training data groups are classified into either a query-dependent data group or a query-independent data group based on the presence or absence of a query.

The importance estimation model m1 is a neural network that estimates an important portion of the source text. Specifically, the importance estimation model m1 is a neural network that calculates an importance value [0,1] for each word in the source text. Here, the importance is the probability that a word will be included in the summary data. In the present embodiment, an example is described in which an importance value is calculated for each word, but the importance value may be calculated for sentences or the like, or for another group of components of the source text. In this case, the term “word” in the present embodiment may be replaced with the aforementioned group of components (e.g., “sentence”).

Query-dependent data is training data constituted by a set of four parameters: {source text, query, extractive summary data, information indicating whether or not words are to be included in summary data}.

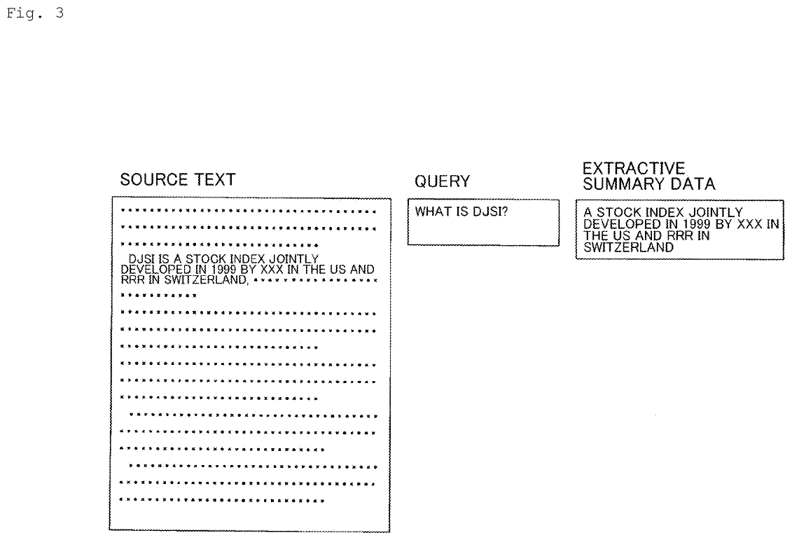

FIG. 3 is a diagram showing an example of query-dependent data. As shown in FIG. 3, the extractive summary data in the query-dependent data is data that corresponds to a portion or range of the source text that is related to the query. Note that in FIG. 3, the information indicating whether or not words are to be included in the summary data has been omitted for the sake of convenience.

On the other hand, query-independent data is training data constituted by a set of three parameters: {source text, generative summary data, and information indicating whether or not words are to be included in summary data}.

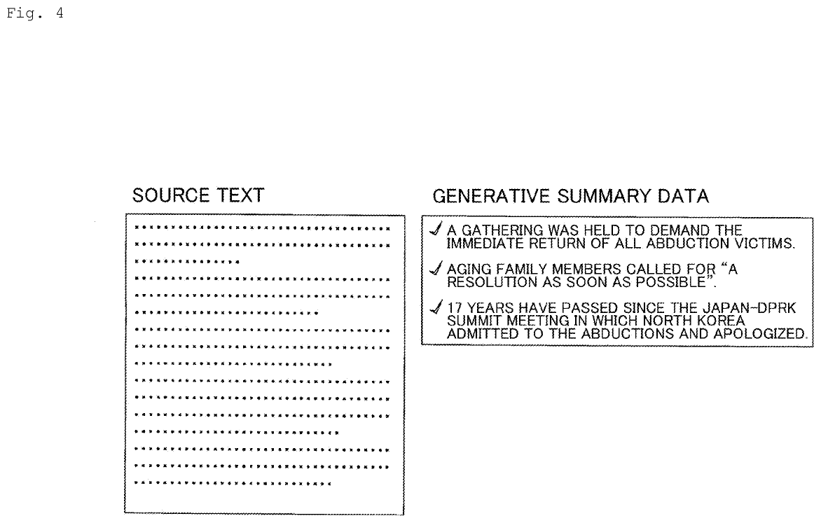

FIG. 4 is a diagram showing an example of query-independent data. In FIG. 4, the generative summary data in the query-independent data is not text data that has been extracted as-is from the source text, but rather is text data that was generated based on the source text. Accordingly, the generative summary data does not necessarily exactly match portions of the source text. Note that in FIG. 4, the information indicating whether or not words are to be included in the summary data has been omitted for the sake of convenience.

Note that in the present embodiment, the term “summary data” will simply be used when there is no need to distinguish between extractive summary data and generative summary data.

In both the query-dependent data and the query-independent data serving as training data, the “information indicating whether or not words are to be included in summary data” is a set of numerical values indicating “1” if a word constituting the source text is to be included in the summary data and “0” if it is not to be included in the summary data.

The reason why the summary data of the query-dependent data is extractive summary data is that, whereas query-independent training data (query-independent data) can be easily collected for a generative summary, query-dependent training data (training data that includes generative summary data) is difficult to collect. In view of this, in the present embodiment, machine-interpreted data used for extractive summary learning, such as the data shown in FIG. 3, is used as “query-dependent data”. Extractive summarization is a summarization method in which a portion of the source text is extracted as-is as summary data.

The important word extraction unit 12 uses the importance estimation model m1 learned by the importance estimation model learning unit 11 to extract k words in order of highest importance value (important words) from the source text of each piece of query-independent data.

The generation model learning unit 13 learns a generation model m2 based on the query-independent data group and the extraction results obtained by the important word extraction unit 12. The generation model m2 is a neural network that generates generative summary data when given source text, extraction results, and the like as input. In other words, in the present embodiment, the learning of the generation model m2 is performed without using query-dependent data (machine-interpreted data).

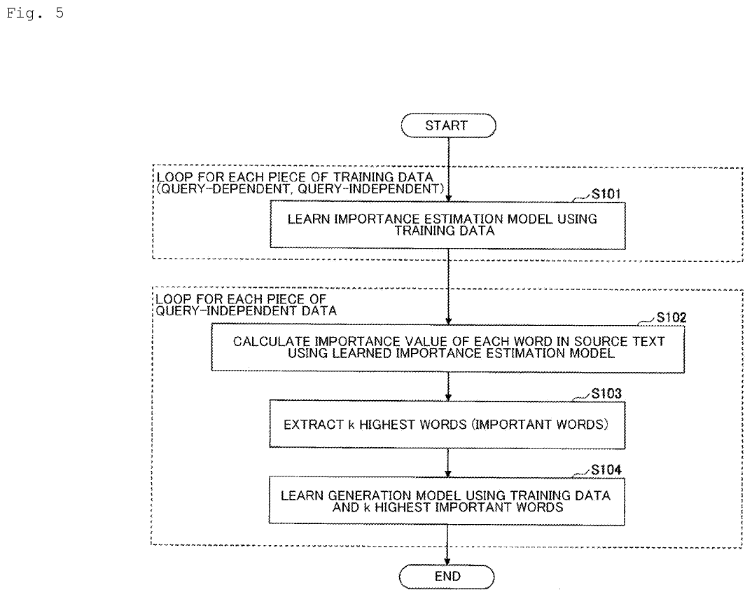

The following describes a processing procedure executed by the summary learning device 10. FIG. 5 is a flowchart for describing an example of the processing procedure of model learning processing.

In step S101, the importance estimation model learning unit 11 executes processing to learn the importance estimation model m1 by, for each piece of training data prepared in advance, applying the training data to a pre-learning model such as BERT. Assuming that there are four pieces of query-dependent data A to D and four pieces of query-independent data E to H, step S101 is executed for each of A to H.

Specifically, if query-dependent data is the processing target, the source text and the query of the query-dependent data are input to the importance estimation model m1, and if query-independent data is the processing target, the source text of the query-independent data is input to the importance estimation model m1. The learning parameters of the importance estimation model m1 are updated based on the importance values output from the importance estimation model m1 for the input data as well as the loss calculated based on 0 or 1 for each word in the training data, and thus the importance estimation model m1 is learned. At this time, the BERT parameters, the importance linear conversion parameters, and the like are shared between the case where query-dependent data is the processing target and the case where query-independent data is the processing target, and one importance estimation model m1 is learned. Note that importance estimation may be realized using the method disclosed in “Itsumi Saito, Kyosuke Nishida, Atsushi Otsuka, Kosuke Nishida, Hisako Asano, Junji Tomita, ‘Document Summary Model Considering Query/Output Length’, 25th Annual Meeting of the Association for Natural Language Processing (NLP2019), https://www.anlp.jp/proceedings/annual_meeting/2019/pdf_dir/P2-11.pdf”, or it may be realized by another method.

The next steps S102 to S104 are executed for each piece of query-independent data. Specifically, in the above example, steps S102 to S104 are executed for each of E to H. Hereinafter, the query-independent data that is to be processed is referred to as “target training data”.

In step S102, the important word extraction unit 12 inputs the source text of the target training data into the importance estimation model m1 that was learned in step S101, and calculates an importance value for each word in the source text.

Subsequently, the important word extraction unit 12 extracts k words in order of highest importance value (important words) from the word group of the source text of the target training data (S103). Here, the length of the summary data in the target training data (the number of words in the summary data) or a value close to the length (e.g., within a ± threshold) is substituted for k in this learning (when the processing procedure of FIG. 5 is executed).

Subsequently, the generation model learning unit 13 inputs the k words having the highest importance value (important words) that were extracted in step S103 and the source text to the generation model m2 so as to learn the generation model m2 (S104). At this time, the loss is calculated based on a comparison between the summary data output from the generation model m2 and the summary data of the target training data. Note that NPL 1 may be referenced as an example for the learning of the generation model m2.

The following describes summary generation processing performed by query-dependent length-controlled generative summarization with use of the importance estimation model m1 and the generation model m2 that were learned as described above.

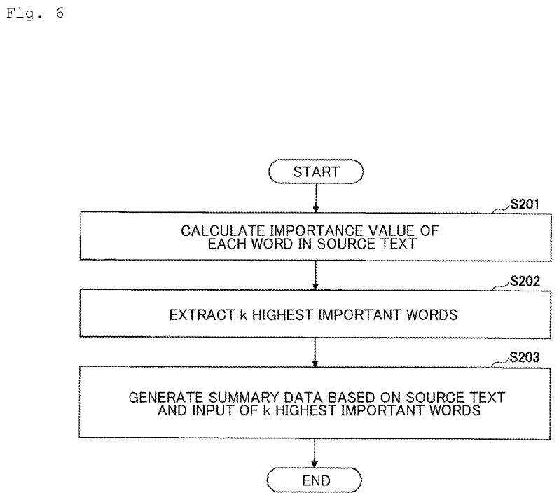

FIG. 6 is a flowchart for describing an example of the processing procedure of summary generation processing. Note that the input parameters for the processing procedure of FIG. 6 are source text, a query, and the length k of summary data. Here, any value (e.g., a user-desired value) is set as k.

In step S201, the importance estimation model m1 calculates the importance value for each word in the source text. Subsequently, the important word extraction unit 12 extracts a plurality of words having the highest importance value (important words) up to the k-th word from the source text (S202). Subsequently, the generation model m2 is given the source text and the k words (important words) as input and generates generative summary data (S203). As a result, query-dependent length-controlled generative summarization of the source text is realized.

As described above, according to the present embodiment, query-dependent length control generative summary learning is performed using query-independent data and query-dependent data. Here, query-dependent data is training data that includes extractive summary data. In other words, the query-dependent data is not generative training data. Accordingly, query-dependent length-controlled generative summary learning can be performed without using query-dependent length-controlled generative summary training data (without direct teacher data). As a result, it is possible to increase efficiency in summary learning that requires an additional input parameter.

Note that in the present embodiment, the importance estimation model learning unit 11 is an example of a first learning unit. The generation model learning unit 13 is an example of a second learning unit. The importance estimation model m1 is an example of a first model. The generation model m2 is an example of a second model. The query-dependent data group is an example of a first training data group. The query-independent data group is an example of a second training data group.

Although an embodiment of the present invention has been described in detail above, the present invention is not limited to this specific embodiment, and various modifications and changes can be made within the gist of the invention described in the claims.

### REFERENCE SIGNS LIST

10 Summary learning device
11 Importance estimation model learning unit
12 Important word extraction unit
13 Generation model learning unit
100 Drive device
101 Recording medium
102 Auxiliary storage device
103 Memory device
104 CPU
105 Interface device
B Bus
m1 Importance estimation model
m2 Generation model

1. A computer implemented method for learning summary, comprising:
learning a first model for calculating an importance value of each component in source text, with use of a first training data group and a second training data group, the first training data group including source text, a query related to a summary of the source text, and summary data related to the query in the source text, and the second training data group including source text and summary data generated based on the source text; and
learning a second model for generating summary data from source text of training data, with use of each piece of training data in the second training data group and a plurality of components extracted for each piece of training data in the second training data group based on importance values calculated by the first model for components of the source text of each piece of training data.

2. The computer implemented method according to claim 1,
wherein a number of components is based on a length of the summary data included in the piece of training data.

3. The computer implemented method according to claim 1, further comprising:
calculating an importance value of each component of source text by inputting the source text and a query related to a summary of the source text to the first model; and
generating summary data for source text by inputting, to the second model, the source text and a plurality of components that were extracted from the source text based on the importance values.

4. A summary learning device comprising a processor configured to execute a method comprising:
learning a first model for calculating an importance value of each component in source text, with use of a first training data group and a second training data group, the first training data group including source text, a query related to a summary of the source text, and summary data related to the query in the source text, and the second training data group including source text and summary data generated based on the source text; and
learning a second model for generating summary data from source text of training data, with use of each piece of training data in the second training data group and a plurality of components extracted for each piece of training data in the second training data group based on importance values calculated by the first model for components of the source text of the piece of training data.

5. The summary learning device according to claim 4,
wherein a number of components extracted is based on a length of the summary data included in the piece of training data.

6. The summary learning device according to claim 4,
wherein an importance value is calculated for each component of source text by inputting the source text and a query related to a summary of the source text to the first model, and summary data is generated for the source text by inputting, to the second model, the source text and a plurality of components that were extracted from the source text based on the importance values.

7. A computer-readable non-transitory recording medium storing computer-executable program instructions that when executed by a processor cause a computer to execute a method comprising:
learning a first model for calculating an importance value of each component in source text, with use of a first training data group and a second training data group, the first training data group including source text, a query related to a summary of the source text, and summary data related to the query in the source text, and the second training data group including source text and summary data generated based on the source text; and
learning a second model for generating summary data from source text of training data, with use of each piece of training data in the second training data group and a plurality of components extracted for each piece of training data in the second training data group based on importance values calculated by the first model for components of the source text of the piece of training data.

8. The computer implemented method according to claim 1, wherein the component corresponds to a word.

9. The computer implemented method according to claim 1, wherein the component corresponds to a sentence.

10. The computer implemented method according to claim 1, wherein the first model further represents, upon trained, an importance estimation model for estimating an importance value for components in a source text of summarizing data, and wherein the first model includes a neural network.

11. The computer implemented method according to claim 1, wherein the second model further represents, upon trained, a generation model for generating generative summary data from a combination of a source text of summarizing data, and wherein the second model includes a neural network.

12. The summary learning device according to claim 4, wherein the component corresponds to a word.

13. The summary learning device according to claim 4, wherein the component corresponds to a sentence.

14. The summary learning device according to claim 4, wherein the first model further represents, upon trained, an importance estimation model for estimating an importance value for components in a source text of summarizing data, and wherein the first model includes a neural network.

15. The summary learning device according to claim 4, wherein the second model further represents, upon trained, a generation model for generating generative summary data from a combination of a source text of summarizing data, and wherein the second model includes a neural network.

16. The computer-readable non-transitory recording medium according to claim 7, wherein a number of components extracted is based on a length of the summary data included in the piece of training data.

17. The computer-readable non-transitory recording medium according to claim 7, the computer-executable program instructions that when executed by a processor further cause a computer to execute a method comprising:
calculating an importance value of each component of source text by inputting the source text and a query related to a summary of the source text to the first model; and
generating summary data for source text by inputting, to the second model, the source text and a plurality of components that were extracted from the source text based on the importance values.

18. The computer-readable non-transitory recording medium according to claim 7, wherein the component corresponds to a word.

19. The computer-readable non-transitory recording medium according to claim 7, wherein the component corresponds to a sentence.

20. The computer-readable non-transitory recording medium according to claim 7,
wherein the first model further represents, upon trained, an importance estimation model for estimating an importance value for components in a source text of summarizing data, and wherein the first model includes a first neural network, and
wherein the second model further represents, upon trained, a generation model for generating generative summary data from a combination of a source text of summarizing data, and wherein the second model includes a second neural network.
